(19) United States
(12) Patent Application Publication
(10) Pub. No.: US 2018/0167634 A1
(43) Pub. Date: Jun. 14, 2018

(54) METHOD AND AN APPARATUS AND A COMPUTER PROGRAM PRODUCT FOR VIDEO ENCODING AND DECODING

(71) Applicant: Nokia Technologies Oy, Espoo (FI)

(72) Inventors: Marja SALMIMAA, Tampere (FI); Miska HANNUKSELA, Tampere (FI); Pekka TALMOLA, Turku (FI)

(21) Appl. No.: 15/832,465

(22) Filed: Dec. 5, 2017

(30) Foreign Application Priority Data
Dec. 9, 2016 (FI) 20165950

(51) Int. Cl. H04N 19/597; H04N 19/33; H04N 19/167

(52) U.S. Cl. CPC H04N 19/597; H04N 19/167; H04N 19/33

(57) ABSTRACT

The invention relates to a method comprising receiving stereoscopic visual data comprising at least one left view image and at least one right view image. An area of interest is determined at the stereoscopic visual data. A first region of the left view image corresponding to a first portion of the area of interest is determined and at least part of the first region is encoded at a first resolution. A second region of the right view image corresponding to a second portion of the area of interest is determined, and at least part of the second region is encoded at a second resolution. The invention also relates to a method for rendering.

### TECHNICAL FIELD

The present solution generally relates to video encoding and decoding.

### BACKGROUND

Since the beginning of photography and cinematography, the most common type of image and video content has been captured by cameras with relatively narrow field of view, and displayed as a rectangular scene on flat displays. More recently, new image and video capture devices are available, which are able to capture visual and audio content all around them. Such content is referred to as 360-degree image/video

Furthermore, new types of output technologies have been invented and produced, such as head-mounted displays. These devices allow a person to see visual content all around him/her. The new capture and display paradigm, where the field of view is spherical, is commonly referred to as virtual reality (VR) and is believed to be the common way people will experience media content in the future.

### SUMMARY

Now there has been invented an improved method and technical equipment implementing the method, for reducing data rates needed for virtual reality content. Various aspects of the invention include a method, an apparatus and a computer readable medium comprising a computer program stored therein, which are characterized by what is stated in the independent claims. Various embodiments of the invention are disclosed in the dependent claims.

According to a first aspect, there is provided a method comprising receiving stereoscopic visual data, the stereoscopic visual data comprising at least one left view image and at least one right view image; determining an area of interest at the stereoscopic visual data; determining a first region of the left view image corresponding to a first portion of the area of interest and encoding at least part of the first region at a first resolution; and determining a second region of the right view image corresponding to a second portion of the area of interest and encoding at least part of the second region at a second resolution.

According to an embodiment, the first and second regions comprise at least partially different portions of the area of interest.

According to an embodiment, the first and second resolutions are different.

According to an embodiment, the first and second regions are at least partially overlapping.

According to an embodiment, the first and second regions define an overlapping area, wherein the resolution at the first region gradually increases towards a first border of the overlapping area, and wherein the resolution at the second region gradually decreases towards the first border of the overlapping area.

According to an embodiment, the method further comprises applying a first filtering to the at least part of the first region to obtain the first resolution and applying a second filtering to the at least part of the second region to obtain the second resolution.

According to an embodiment, the first and second resolutions are each higher than a base resolution of the stereoscopic visual data.

According to an embodiment, the first resolution is equal to the second resolution.

According to an embodiment, the base resolution is lower than the first resolution and/or the second resolution.

According to an embodiment, the method further comprises encoding at least a part of the at least one left view image and at least a part of the at least one right view image onto one or more scalable layers of a bitstream, wherein the at least part of the first region is encoded onto a first scalable layer of the bitstream, and the at least part of the second region is encoded onto a second scalable layer of the bitstream, the first and second scalable layers being different layers of the one or more scalable layers.

According to an embodiment, the method further comprises selecting the area of interest, the first region, or the second region based on at least one of the following: detecting a close-by object; detecting an high spatial frequency object; detecting a face of an object; detecting an alphanumeric object; detecting an orientation of a user and detecting a gaze position of a user.

According to an embodiment, the stereoscopic visual data comprises a portion of 360-degree virtual reality content.

According to a second aspect, there is provided an apparatus comprising at least one processor, memory including computer program code, the memory and the computer program code configured to, with the at least one processor, cause the apparatus to receive stereoscopic visual data, the stereoscopic visual data comprising at least one left view image and at least one right view image; determine an area of interest at the stereoscopic visual data; determine a first region of the left view image corresponding to a first portion of the area of interest and encoding at least part of the first region at a first resolution; and determine a second region of the right view image corresponding to a second portion of the area of interest and encoding at least part of the second region at a second resolution.

According to a third aspect, there is provided a computer program product embodied on a non-transitory computer readable medium, comprising computer program code configured to, when executed on at least one processor, cause an apparatus or a system to receive stereoscopic visual data, the stereoscopic visual data comprising at least one left view image and at least one right view image; determine an area of interest at the stereoscopic visual data; determine a first region of the left view image corresponding to a first portion of the area of interest and encoding at least part of the first region at a first resolution; and determine a second region of the right view image corresponding to a second portion of the area of interest and encoding at least part of the second region at a second resolution.

According to a fourth aspect, there is provided a method comprising decoding, at a first resolution, at least part of a first region of a left view image corresponding to a first portion of an area of interest; decoding, at a second resolution, at least part of a second region of a right view image corresponding to a second portion of the area of interest; and rendering the at least part of the first region and the at least part of the second region.

According to an embodiment, the method further comprises obtaining at least one of device orientation information, head orientation information, and a gaze direction; determining either the first region or the second region to be rendered at the first resolution or the second resolution, respectively, based on the device orientation information, the head orientation information, the gaze direction, or a combination thereof; and rendering either the at least part of the first region at the first resolution corresponding to a first region of the left view image corresponding to a first portion of the area of interest or the at least part the second region at the second resolution.

According to a fifth aspect, there is provided an apparatus comprising at least one processor, memory including computer program code, the memory and the computer program code configured to, with the at least one processor, cause the apparatus to decode, at a first resolution, at least part of a first region of a left view image corresponding to a first portion of an area of interest; to decode, at a second resolution, at least part of a second region of a right view image corresponding to a second portion of the area of interest; and to render the at least part of the first region and the at least part of the second region.

According to a sixth aspect, there is provided a computer program product embodied on a non-transitory computer readable medium, comprising computer program code configured to, when executed on at least one processor, cause an apparatus or a system to decode, at a first resolution, at least part of a first region of a left view image corresponding to a first portion of an area of interest; to decode, at a second resolution, at least part of a second region of a right view image corresponding to a second portion of the area of interest; and to render the at least part of the first region and the at least part of the second region.

### DESCRIPTION OF THE DRAWINGS

In the following, various embodiments of the invention will be described in more detail with reference to the appended drawings, in which

FIG. 1 shows an apparatus according to an embodiment in a simplified block chart,

FIG. 2 shows a layout of an apparatus according to an embodiment;

FIG. 3 shows a display device according to an embodiment;

FIG. 4 shows an encoder according to an embodiment;

FIG. 5 shows a decoder according to an embodiment;

FIG. 6 shows an example of preparation of 360-degree image/video content;

FIG. 7 shows an example of a process of forming a monoscopic equirectangular panorama picture;

FIG. 8 shows an example of a packed virtual reality (VR) frame;

FIGS. 9-14a, b show examples of determining an area of interest from a visual content;

FIG. 15 shows an encoding method according to an embodiment; and

FIG. 16 shows a decoding method according to an embodiment.

### DETAILED DESCRIPTION

The present embodiments facilitate the reduction of the data rates needed for virtual reality content. The present embodiments are suitable for low-latency high-bandwidth transmission channels, such as cable and wireless local connections and 5G mobile networks, where inter-picture prediction may not be used or used only in limited fashion. However, the teachings of the present embodiments may be applied to higher-latency and/or lower-bandwidth transmission channels too.

Virtual reality video content requires a high bandwidth for example because the spatial resolution should be high to achieve high enough spatial fidelity. For example, some head-mounted displays (HMD) currently use quad-HD panels (2560×1440). It is also assumed that the HMD panels may reach 8K resolution (e.g. 7680×4320) for example within five years. High bandwidth is required also because the temporal resolution should be high to achieve quick enough response to head movements. For example, it is recommended to use the same or greater frame rate as the display refresh rate. Even higher display refresh rates and similarly frame rates are desirable.

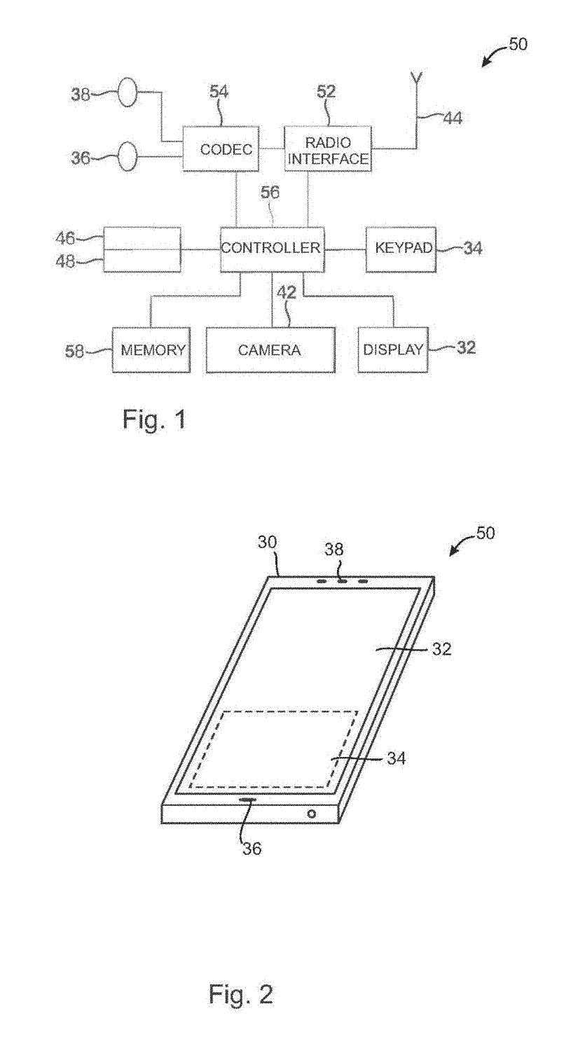

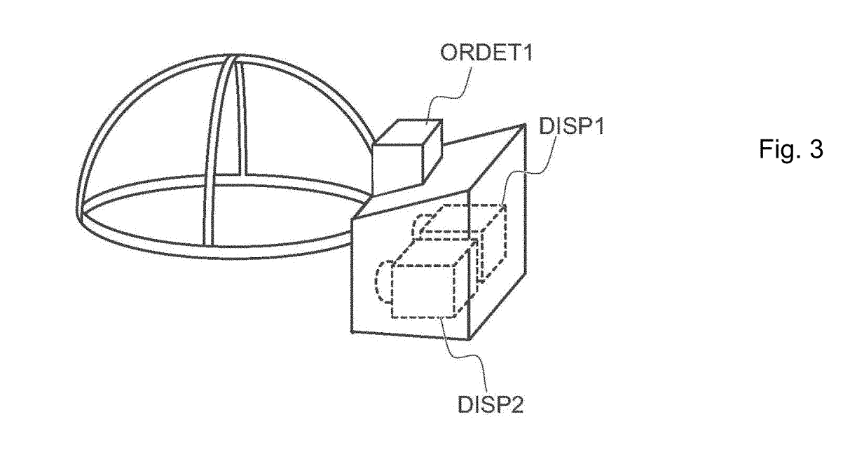

In the present embodiments, the data rate reduction may be achieved by allowing input pictures for encoding to have varying resolutions within a picture. Before describing the present solution in more detailed manner, an apparatus according to an embodiment is disclosed with reference to FIGS. 1 and 2.

FIG. 1 shows a block diagram of a video coding system according to an example embodiment as a schematic block diagram of an electronic device 50, which may incorporate a codec. In some embodiments the electronic device may comprise an encoder or a decoder. FIG. 2 shows a layout of an apparatus according to an embodiment. The electronic device 50 may for example be a mobile terminal or a user equipment of a wireless communication system or a camera device. The electronic device 50 may be also comprised at a local or a remote server or a graphics processing unit of a computer. The device may be also comprised as part of a head-mounted display device.

The apparatus 50 may comprise a housing 30 for incorporating and protecting the device. The apparatus 50 may further comprise a display 32 in the form of a liquid crystal display. In other embodiments of the invention the display may be any suitable display technology suitable to display an image 30 or video. The apparatus 50 may further comprise a keypad 34. In other embodiments of the invention any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. The camera 42 is a multi-lens camera system having at least two camera sensors. The camera is capable of recording or detecting individual frames which are then passed to the codec 54 or the controller for processing. The apparatus may receive the video and/or image data for processing from another device prior to transmission and/or storage.

The apparatus 50 may further comprise an infrared port for short range line of sight communication to other devices. According to an embodiment, the apparatus may further comprise any suitable short range communication solution such as for example a Bluetooth wireless connection or a USB (Universal Serial Bus)/firewire wired connection.

The apparatus 50 may comprise a controller 56 or processor for controlling the apparatus 50. The apparatus or the controller 56 may comprise one or more processors or processor circuitry and be connected to memory 58 which may store data in the form of image, video and/or audio data, and/or may also store instructions for implementation on the controller 56 or to be executed by the processors or the processor circuitry. The controller 56 may further be connected to codec circuitry 54 suitable for carrying out coding and decoding of image, video and/or audio data or assisting in coding and decoding carried out by the controller.

The apparatus 50 may further comprise a card reader 48 and a smart card 46, for example a UICC (Universal Integrated Circuit Card) and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The 30 apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es). The apparatus may comprise one or more wired interfaces configured to transmit and/or receive data over a wired connection, for example an electrical cable or an optical fiber connection. Such wired interface may be configured to operate according to one or more digital display interface standards, such as for example High-Definition Multimedia Interface (HDMI), Mobile High-definition Link (MHL), or Digital Visual Interface (DVI).

An apparatus according to another embodiment is disclosed with reference to FIG. 3. FIG. 3 shows a block diagram of a video decoding system according to an example embodiment as a schematic block diagram of an electronic device. The video decoding system of FIG. 3 is a head-mounted display for stereo viewing. The head-mounted display comprises two screen sections or two screens DISP1 and DISP2 for displaying the left and right eye images. The displays are close to the eyes, and therefore lenses are used to make the images easily viewable and for spreading the images to cover as much as possible of the eyes' field of view. The device is attached to the head of the user so that it stays in place even when the user turns his head. The device may have an orientation detecting circuitry ORDET1 for determining the head movements and direction of the head. The orientation detecting circuitry output may be also used for estimating user's gaze direction, or, the device may comprise gaze detection circuitry for this purpose. The head-mounted display gives a three-dimensional (3D) perception of the recorded/streamed content to a user.

A video codec comprises an encoder that transforms an input video into a compressed representation suited for storage/transmission and a decoder that can uncompress the compressed video representation back into a viewable form. The encoder may discard some information in the original video sequence in order to represent the video in a more compact form (that is, at lower bitrate). An image codec or a picture codec is similar to a video codec, but it encodes each input picture independently from other input pictures and decodes each coded picture independently from other coded pictures. It needs to be understood that whenever a video codec, video encoding or encoder, or video decoder or decoding is referred below, the text similarly applies to an image codec, image encoding or encoder, or image decoder or decoding, respectively.

A picture given as an input to an encoder may also referred to as a source picture, and a picture decoded by a decoded may be referred to as a decoded picture. The source and decoded pictures are each comprised of one or more sample arrays, such as one of the following sets of sample arrays:

Luma (Y) only (monochrome).

Luma and two chroma (YCbCr or YCgCo).

Green, Blue and Red (GBR, also known as RGB).

Arrays representing other unspecified monochrome or tri-stimulus color samplings (for example, YZX, also known as XYZ).

Term pixel may refer to the set of spatially collocating samples of the sample arrays of the color components. Sometimes, depending on the context, term pixel may refer to a sample of one sample array only.

In the following, these arrays may be referred to as luma (or L or Y) and chroma, where the two chroma arrays may be referred to as Cb and Cr; regardless of the actual color representation method in use. The actual color representation method in use can be indicated e.g. in a coded video bitstream. A component may be defined as an array or single sample from one of the three sample arrays (luma and two chroma) or the array or a single sample of the array that compose a picture in monochrome format.

In some coding systems, a picture may either be a frame or a field, while in some coding systems a picture may be constrained to be a frame. A frame comprises a matrix of luma samples and possibly the corresponding chroma samples. A field is a set of alternate sample rows of a frame and may be used as encoder input, when the source signal is interlaced.

Chroma sample arrays may be absent (and hence monochrome sampling may be in use) or chroma sample arrays may be subsampled when compared to luma sample arrays. Chroma formats may be summarized as follows:

In monochrome sampling there is only one sample array, which may be nominally considered the luma array.

In 4:2:0 sampling, each of the two chroma arrays has half the height and half the width of the luma array.

In 4:2:2 sampling, each of the two chroma arrays has the same height and half the width of the luma array.

In 4:4:4 sampling when no separate color planes are in use, each of the two chroma arrays has the same height and width as the luma array.

Spatial resolution of a picture may be defined as the number of pixels or samples representing the picture in horizontal and vertical direction. Alternatively, depending on the context, spatial resolution of a first picture may be defined to be the same as that of a second picture, when their sampling grids are the same, i.e. the same sampling interval is used both in the first picture and in the second picture. The latter definition may be applied for example when the first picture and the second picture cover different parts of a picture. For example, a region of a picture may be defined to have a first resolution when the first region comprises a first number of pixels or samples. The same region may be defined to have a second resolution when the region comprises a second number of pixels. Hence, resolution can be defined as the number of pixels with respect to the area covered by the pixels, or, by pixels per degree.

In some coding arrangements luma and chroma sample arrays are coded in an interleaved manner, e.g. interleaved block-wise. In some coding arrangements, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

Video encoders may encode the video information in two phases.

Firstly, pixel values in a certain picture area (or “block”) are predicted. The prediction may be performed for example by motion compensation means (finding and indicating an area in one of the previously coded video frames that corresponds closely to the block being coded), which may be referred to as inter prediction or inter-picture prediction. Alternatively or in addition, the prediction may be performed for example by spatial means (using the pixel values around the block to be coded in a specified manner), which may be referred to as intra prediction or spatial prediction. In some coding arrangements, prediction may be absent or the prediction signal may be pre-defined (e.g. a zero-valued block).

Secondly, the prediction error, i.e. the difference between the predicted block of pixels and the original block of pixels, is coded. This may done for example by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate). In another example, pixel values are coded without transforming them for example using differential pulse code modulation and entropy coding, such as Huffman coding or arithmetic coding.

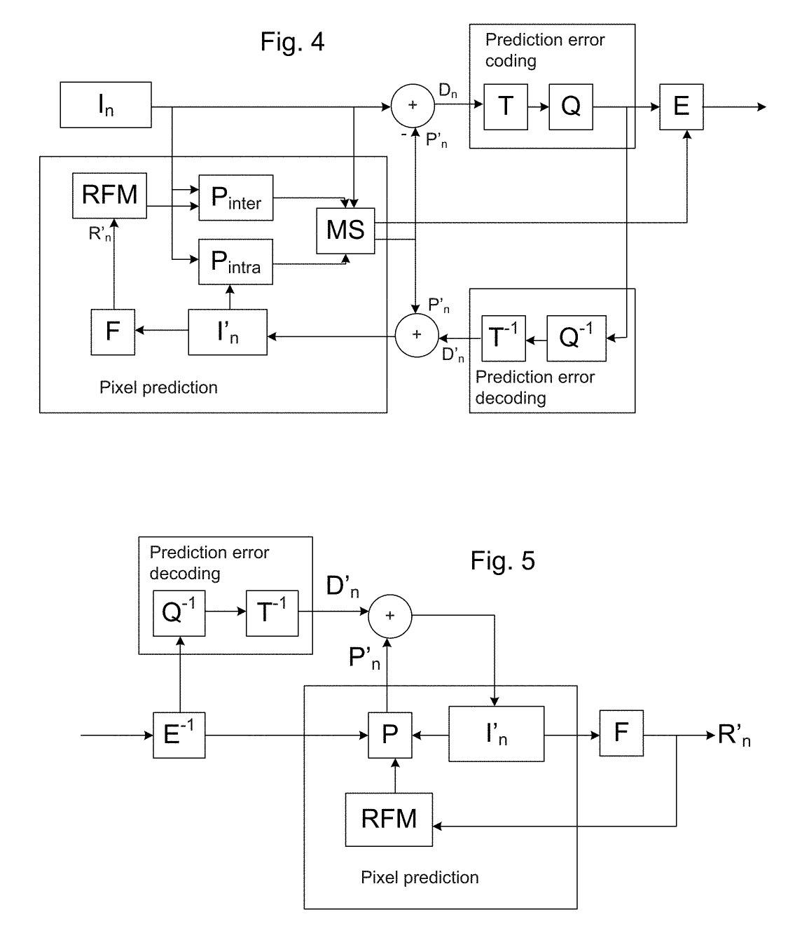

An example of an encoding process is illustrated in FIG. 4. FIG. 4 illustrates an image to be encoded (Iₐ); a predicted representation of an image block (P′ₙ); a prediction error signal (Dₙ); a reconstructed prediction error signal (D′ₙ); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ); mode selection (MS) and filtering (F). An example of a decoding process is illustrated in FIG. 5. FIG. 5 illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

In signal processing, resampling of images is usually understood as changing the sampling rate of the current image in horizontal or/and vertical directions. Resampling results in a new image which is represented with different number of pixels in horizontal or/and vertical direction. In some applications, the process of image resampling is equal to image resizing. In general, resampling is classified in two processes: downsampling (a.k.a. subsampling) and upsampling.

Downsampling or subsampling process may be defined as reducing the sampling rate of a signal, and it typically results in reducing of the image sizes in horizontal and/or vertical directions. In image downsampling, the spatial resolution of the output image, i.e. the number of pixels in the output image, is reduced compared to the spatial resolution of the input image. Downsampling ratio may be defined as the horizontal or vertical resolution of the downsampled image divided by the respective resolution of the input image for downsampling. Downsampling ratio may alternatively be defined as the number of samples in the downsampled image divided by the number of samples in the input image for downsampling. As the two definitions differ, the term downsampling ratio may further be characterized by indicating whether it is indicated along one coordinate axis or both coordinate axes (and hence as a ratio of number of pixels in the images). Image downsampling may be performed for example by decimation, i.e. by selecting a specific number of pixels, based on the downsampling ratio, out of the total number of pixels in the original image. In some embodiments downsampling may include low-pass filtering or other filtering operations, which may be performed before or after image decimation. Any low-pass filtering method may be used, including but not limited to linear averaging.

Upsampling process may be defined as increasing the sampling rate of the signal, and it typically results in increasing of the image sizes in horizontal and/or vertical directions. In image upsampling, the spatial resolution of the output image, i.e. the number of pixels in the output image, is increased compared to the spatial resolution of the input image. Upsampling ratio may be defined as the horizontal or vertical resolution of the upsampled image divided by the respective resolution of the input image. Upsampling ratio may alternatively be defined as the number of samples in the upsampled image divided by the number of samples in the input image. As the two definitions differ, the term upsampling ratio may further be characterized by indicating whether it is indicated along one coordinate axis or both coordinate axes (and hence as a ratio of number of pixels in the images). Image upsampling may be performed for example by copying or interpolating pixel values such that the total number of pixels is increased. In some embodiments, upsampling may include filtering operations, such as edge enhancement filtering.

Scalable video coding may refer to coding structure where one bitstream can contain multiple representations of the content, for example, at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A meaningful decoded representation can be produced by decoding only certain parts of a scalable bit stream. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance, for example, the temporal resolution (i.e., the frame rate), the spatial resolution, or simply the quality of the video content represented by another layer or part thereof. Each layer together with all its dependent layers is one representation of the video signal, for example, at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer.
Spatial scalability: Base layer pictures are coded at a lower resolution (i.e. have fewer samples) than enhancement layer pictures. Spatial scalability and quality scalability, particularly its coarse-grain scalability type, may sometimes be considered the same type of scalability.
Bit-depth scalability: Base layer pictures are coded at lower bit-depth (e.g. 8 bits) than enhancement layer pictures (e.g. 10 or 12 bits).
Chroma format scalability: Base layer pictures provide lower spatial resolution in chroma sample arrays (e.g. coded in 4:2:0 chroma format) than enhancement layer pictures (e.g. 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
View scalability, which may also be referred to as multiview coding. The base layer represents a first view, whereas an enhancement layer represents a second view.
Depth scalability, which may also be referred to as depth-enhanced coding. A layer or some layers of a bitstream may represent texture view(s), while other layer or layers may represent depth view(s).
Region-of-interest scalability. ROI scalability may be defined as a type of scalability wherein an enhancement layer enhances only part of a reference-layer picture e.g. spatially, quality-wise, in bit-depth, and/or along other scalability dimensions. As ROI scalability may be used together with other types of scalabilities, it may be considered to form a different categorization of scalability types. There exist several different applications for ROI coding with different requirements, which may be realized by using ROI scalability. For example, an enhancement layer can be transmitted to enhance the quality and/or a resolution of a region in the base layer. A decoder receiving both enhancement and base layer bitstream might decode both layers and overlay the decoded pictures on top of each other and display the final picture.
Interlaced-to-progressive scalability (also known as field-to-frame scalability): coded interlaced source content material of the base layer is enhanced with an enhancement layer to represent progressive source content.
Hybrid codec scalability (also known as coding standard scalability): In hybrid codec scalability, the bitstream syntax, semantics and decoding process of the base layer and the enhancement layer are specified in different video coding standards. Thus, base layer pictures are coded according to a different coding standard or format than enhancement layer pictures.

It should be understood that many of the scalability types may be combined and applied together.

The term “layer” may be used in context of any type of scalability, including view scalability and depth enhancements. An enhancement layer may refer to any type of an enhancement, such as SNR, spatial, multiview, depth, bit-depth, chroma format, and/or color gamut enhancement. A base layer may refer to any type of a base video sequence, such as a base view, a base layer for SNR/spatial scalability, or a texture base view for depth-enhanced video coding.

Various technologies for providing three-dimensional (3D) video content are currently investigated and developed. It may be considered that in stereoscopic or two-view video, one video sequence or view is presented for the left eye while a parallel view is presented for the right eye. More than two parallel views may be needed for applications which enable viewpoint switching or for autostereoscopic displays which may present a large number of views simultaneously and let the viewers to observe the content from different viewpoints.

A view may be defined as a sequence of pictures representing one camera or viewpoint. The pictures representing a view may also be called view components. In other words, a view component may be defined as a coded representation of a view in a single access unit. In multiview video coding, more than one view is coded in a bitstream. Since views are typically intended to be displayed on stereoscopic or multiview autostereoscopic display or to be used for other 3D arrangements, they typically represent the same scene and are content-wise partly overlapping although representing different viewpoints to the content. Hence, inter-view prediction may be utilized in multiview video coding to take advantage of inter-view correlation and improve compression efficiency. One way to realize inter-view prediction is to include one or more decoded pictures of one or more other views in the reference picture list(s) of a picture being coded or decoded residing within a first view. View scalability may refer to such multiview video coding or multiview video bitstreams, which enable removal or omission of one or more coded views, while the resulting bitstream remains conforming and represents video with a smaller number of views than originally.

A stream access point (SAP) may be defined as a position in a bitstream (or alike) that enables playback to be started using only the information from that position onwards (possibly in addition to specific initialization data). Several types of SAP may be specified, including the following. SAP Type 1 may be defined to correspond to what is known in some coding schemes as a “Closed GOP (Group of Pictures) random access point” (in which all pictures, in decoding order, can be correctly decoded, resulting in a continuous time sequence of correctly decoded pictures with no gaps) and in addition the first picture in decoding order is also the first picture in presentation order. SAP Type 2 may be defined to correspond to what is known in some coding schemes as a “Closed GOP random access point” (in which all pictures, in decoding order, can be correctly decoded, resulting in a continuous time sequence of correctly decoded pictures with no gaps), for which the first picture in decoding order may not be the first picture in presentation order. SAP Type 3 may be defined to correspond to what is known in some coding schemes as an “Open GOP random access point”, in which there may be some pictures in decoding order that cannot be correctly decoded and have presentation times less than intra-coded picture associated with the SAP, but all pictures following the SAP in presentation order can be correctly decoded. Stream access points (which may also or alternatively be referred to as layer access point) for layered coding may be defined similarly in a layer-wise manner A SAP for layer may be defined as a position in a layer (or alike) that enables playback of the layer to be started using only the information from that position onwards assuming that the reference layers of the layer have already been decoded earlier.

In the present application, terms “360-degree video” or “virtual reality (VR) video” may be used interchangeably. The terms generally refers to video content that provides such a large field of view that only a part of the video is displayed at a single point of time in typical displaying arrangements. For example, VR video may be viewed on a head-mounted display (HMD) (as the one shown in FIG. 3) that may be capable of displaying e.g. about 100-degree field of view. The spatial subset of the VR video content to be displayed may be selected based on the orientation of the HMD. In a conventional flat-panel viewing environment, which represents another example of the viewing environment, e.g. up to 40-degree field of view may be displayed. When displaying wide field of view content (e.g., fisheye) on such flat-panel display, a spatial subset of the picture may be displayed instead of the entire picture. In such example, the displayed spatial subset of the VR video content may be selected based on the orientation of the device used for the viewing, or the device may enable content panning, e.g., by providing basic user interface (UI) controls for the user.

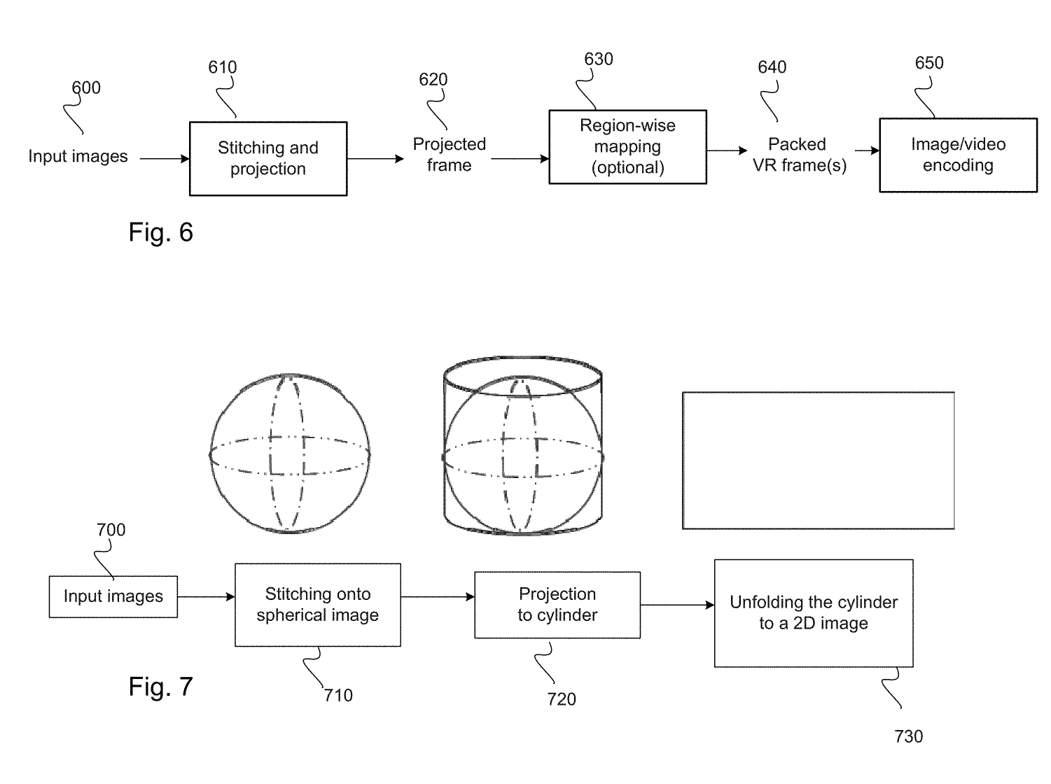

360-degree image or video content may be acquired and prepared for example as follows. Images or video can be captured by a set of cameras or a camera device with multiple lenses and sensors. The acquisition results in a set of digital image/video signals. The cameras/lenses may cover all directions around the center point of the camera set or the camera device. The images of the same time instance are stitched, projected, and mapped onto a packed VR frame. FIG. 6 illustrates an example of such process. At first, input images 600 are obtained from a camera device. These input images are stitched and projected 610 onto a three-dimensional projection structure, such as a sphere or a cube. The projection structure may be considered to comprise one or more surfaces, such as plane(s) or part(s) thereof. The projection structure may be defined as three-dimensional structure consisting of one or more surface(s) on which the captured VR image/video content is projected, and from which a respective projected frame can be formed. The image data on the projection structure is further arranged onto a two-dimensional projected frame 620. The term projection may be defined as a process by which a set of input images are projected onto a projected frame. There may be a pre-defined set of representation formats of the projected frame, including for example an equirectangular panorama and a cube map representation format.

Region-wise mapping 630 may optionally be applied to map projected frame onto one or more packed VR frames 640. In some cases, region-wise mapping is understood to be equivalent to extracting two or more regions from the projected frame, optionally applying a geometric transformation (such as rotating, mirroring, and/or resampling) to the regions, and placing the transformed regions in spatially non-overlapping areas, a.k.a. constituent frame partitions, within the packed VR frame. If the region-wise mapping is not applied, the packed VR frame is identical to the projected frame. Otherwise, regions of the projected frame are mapped onto a packed VR frame by indicating the location, shape, and size of each region in the packed VR frame. The term mapping may be defined as a process by which a projected frame is mapped to a packed VR frame. The term packed VR frame may be defined as a frame that results from a mapping of a projected frame. In practice, the input images may be converted to a packed VR frame in one process without intermediate steps. The packed VR frame(s) are then provided for image/video encoding 650.

360-degree panoramic content (i.e., images and video) cover horizontally the full 360-degree field of view around the capturing position of a camera device. The vertical field of view may vary and can be e.g., 180 degrees. Panoramic image covering 360-degree field of view horizontally and 180-degree field of view vertically can be represented by a sphere that has been mapped to a two-dimensional image plane using equirectangular projection. In this case, the horizontal coordinate may be considered equivalent to a longitude, and the vertical coordinate may be considered equivalent to latitude, with no transformation or scaling applied. The process of forming a monoscopic equirectangular panorama picture is illustrated in the FIG. 7. A set of input images 700, such as fisheye images of a camera array or from a camera device with multiple lenses and sensors, is cross blended or stitched 710 onto a spherical image (equidistant projection). The spherical image is further projected onto a cylinder 720 (without the top and bottom faces). The cylinder is unfolded to form a two-dimensional projected frame 730. In practice one or more of the presented steps may be merged; for example, the input images may be directly projected onto a cylinder without an intermediate projection onto a sphere. The projection structure for equirectangular panorama may be considered to be a cylinder that comprises a single surface. Similarly, stereoscopic equirectangular panorama pictures can be formed from a set of input images for the left and right eyes. In stereoscopic equirectangular panoramas the upper part of the panorama may be the left-eye images, and the lower part of the panorama may be the right-eye image.

In general, 360-degree content can be mapped onto different types of solid geometrical structures, such as polyhedron (i.e., a three-dimensional solid object containing flat polygonal faces, straight edges and sharp corners or vertices, e.g., a cube or a pyramid), cylinder (by projecting a spherical image onto the cylinder, as described above with the equirectangular projection), cylinder (directly without projecting onto sphere first), cone, etc. and then unwrapped to a two-dimensional image plane.

In some cases panoramic content with 360-degree horizontal field of view but with less than 180-degree vertical field of view may be considered special cases of equirectangular projection, where the polar areas of the sphere have not been mapped onto the two-dimensional image plane. In some cases a panoramic image may have less than 360-degree horizontal field of view and up to 180-degree vertical field of view, while otherwise has the characteristics of equirectangular projection format.

The human eyes are not capable of viewing the whole 360-degree space, but are limited to a maximum horizontal and vertical Field of Views (FoVs, Human eye Horizontal FoV (HHFoV); Human eye Vertical FoV (HVFov)). Also, a HMD device has technical limitations that allow only viewing a subset of the whole 360 degrees spaces in horizontal and vertical directions (Device Horizontal FoV (DHFoV); Device Vertical FoV (DVFoV)).

At any point of time, a video rendered by an application on a HMD renders a portion of the 360 degrees video. This portion if defined in this application as “viewport”. A viewport is a window on the 360-degree world represented in the omnidirectional video displayed via a rendering display. A viewport is characterized by horizontal and vertical FoVs (Viewport Horizontal FoV (VHFoV); Viewport Vertical FoV (VVFoV)). In the following, VHFoV and VVFoV will be simply abbreviated with HFoV and VFoV.

A viewport size may correspond to the HMD FoV, or may have smaller or larger size, depending on the application. For the sake of clarity, a part of the 360 degrees space viewed by a user at any given point of time is referred as a “primary viewport”.

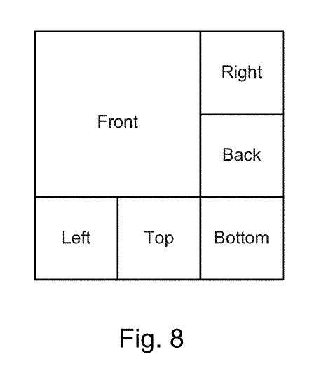

One method to reduce the streaming bitrate of VR video is viewport adaptive streaming (a.k.a. viewport dependent delivery). In such streaming a subset of 360-degree video content covering the primary viewport (i.e., the current view orientation) is transmitted at the best quality/resolution, while the remaining of 360-degree video is transmitted at a lower quality/resolution. There are generally two approaches for viewport-adaptive streaming:
1) Viewport-specific encoding and streaming, a.k.a. viewport-dependent encoding and streaming, a.k.a. asymmetric projection, a.k.a. packed VR video. In this approach, 360-degree image content is packed into the same frame with an emphasis (e.g., greater spatial area) on the primary viewport. The packed VR frames are encoded into a single bitstream. For example, the front face of a cube map may be sampled with a higher resolution compared to other cube faces, and the cube faces may be mapped to the same packed VR frame as shown in FIG. 8.
2) VR viewport video, a.k.a. tile-based encoding and streaming. In this approach, 360-degree content is encoded and made available in a manner that enables selective streaming of viewports from different encodings. For example, each cube face may be separately encoded. More than one encoded bitstream for each cube face may be provided, e.g. each with different spatial resolution. Players can choose bitstreams to be decoded and played based on the current viewing orientation. High-resolution bitstreams may be selected for the cube faces used for rendering for the present viewing orientation, while the remaining cube faces may be obtained from their low-resolution bitstreams.

It is possible to combine the approaches 1) and 2) above.

The 360 degrees space can be assumed to be divided into a discrete set of viewports, each separated by a given distance (e.g., expressed in degrees), so that the omnidirectional space can be imagined as a map of overlapping viewports, and the primary viewport is switched discretely as the user changes his/her orientation while watching content with a HMD. When the overlapping between viewports is reduced to zero, the viewports could be imagined as adjacent non-overlapping tiles within the 360 degrees space.

Video interface that may be used by the head mounted displays is HMDI, a serial interface where the video information in transmitted in three TMDS channels (RGB, YCbCr) as Video Data Periods. in another video interface, superMHL, there are more (6 to 8) TMDS channels, which can be used in a more flexible way to transmit video and other data, the main difference being that MHL transmits RGB (or YCbCr) information of a pixel sequentially over the one TMDS channel.

A transmission channel or a communication channel or a channel may refer to either a physical transmission medium, such as a wire, or to a logical connection over a multiplexed medium. Examples of channels comprise lanes in video interface cables and a Real-Time Transport Protocol (RTP) stream.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietf.org/rfc/rfc3550.txt. In RTP transport, media data is encapsulated into RTP packets. Typically, each media type or media coding format has a dedicated RTP payload format.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver may group packets by synchronization source for playback. Examples of synchronization sources include the sender of a stream of packets derived from a signal source such as a microphone or a camera, or an RTP mixer. Each RTP stream is identified by a SSRC that is unique within the RTP session.

As mentioned, virtual reality video content requires a high bandwidth. Viewport-dependent methods as described above in the context of streaming may be used also in for “local” transmission of virtual reality video over a cable connection or a local wireless connection. However, the bitrates remain to be very high and challenging for cable and wireless connections. For example, the raw data rate of 7680×4320 8-bit pictures at 90 Hz is more than 71 Gbps.

The round-trip delay from the video processing device (e.g. PC processing the video for rendering) and the display device (e.g. HMD), including all the processing steps, may be higher than the display refresh rate and correspondingly the frame rate. Consequently, the intended viewport of a picture prepared for rendering may not exactly match the prevailing display viewport when the picture is about to be displayed. Thus, even local connections may require transmission of pictures with a higher field of view than what eventually are displayed.

The compression scheme for the pictures transmitted over local display connections does not typically include inter-picture prediction to reduce the computational complexity and memory requirements in the display device. Consequently, data rates are typically proportional to the picture rate.

Possible solutions for reducing the required data rate include e.g. emphasizing the center of the image, correcting image immediately prior to display, compression, different resolutions for different eyes at a region of interest.

In the present solution for reducing the data rates, the encoding and transmission of areas of interest are enabled in an asymmetric manner, and hence reducing the required bandwidth for transmitting them. It is expected that human visual system will perceive the displayed image data as if both views were transmitted at the high quality and resolution. Furthermore, the present embodiments enable to encode and transmit the stereoscopic video data that is not within the areas of interest at a lower resolution and hence lower bitrate, assuming the areas of interest accurately represent the focused content (e.g. as response of gaze tracking).

A method according to an embodiment comprises receiving stereoscopic visual data, wherein the stereoscopic visual data comprises at least one left view image and at least one right view image. An area or interest at the stereoscopic visual data is determined. In addition a first region of the left view image corresponding to a first portion of the area of interest is determined, and at least part of the first region is encoded at a first resolution. Similarly, a second region of the right view image corresponding to a second portion of the area of interest is determined, and at least part of the second region is encoded at a second resolution. In method, the first and second resolutions may be different.

According to an embodiment, the first and the second regions may comprise at least partially different portion of the area of interest, wherein the resolution at the first regions increases gradually within the first region, and/or wherein the resolution at the second region increase gradually within the second region.

According to an embodiment, the first and second regions may be at least partially overlapping. In such embodiment, the first and second regions may define an overlapping area, wherein the resolution at the first region increases gradually towards a first border of the overlapping area, and wherein the resolution at the second region decreases towards the first border of the overlapping area.

According to an embodiment, which can be combined with any other previous embodiment, a first filtering may be applied to at least the part of the first region to effectively obtain the first resolution, and a second filtering may be applied to at least the part of the second region to effectively obtain the second resolution.

According to an embodiment, the first and second resolutions may each be higher than a base resolution of the stereoscopic visual data. In such embodiment, the first resolution may be equal to the second resolution, and/or the base resolution may be lower than the first resolution and/or the second resolution; and/or at least a part of the at least one left view image and at least a part of the at least one right view image may be encoded at the base resolution onto one or more scalable layers of a bitstream, wherein the at least part of the first region may be encoded onto a first scalable layer of the bitstream, and the at least part of the second region may be encoded onto a second scalable layer of the bitstream, the first and second scalable layers being different from the one or more scalable layers.

According to an embodiment, the area of interest may be selected based on at least one of the following: detecting a close-by object; detecting a high spatial frequency object; detecting a face of an object; detecting an alphanumeric object; detecting an orientation of a user; detecting a gaze position of a user.

According to an embodiment the stereoscopic visual data may comprise a portion of 360-degree virtual reality content.

In an embodiment for encoding, the coding method allows input pictures for encoding to have varying resolution within a picture. A varying-resolution picture may for example be a packed VR frame as explained earlier. The region-wise mapping that was applied to a projected picture to obtain the packed VR frame may be indicated as metadata in or along a bitstream. In another example, a varying-resolution picture is a projected frame that has been sampled non-uniformly from a projection structure.

A base resolution of the stereoscopic visual data may be achieved by filtering one view or both views of the received stereoscopic visual data (having an original resolution). For example, low-pass filtering may be applied. The applied filtering may be such that the stereoscopic visual data may be resampled to a lower resolution with no or minor aliasing. In an embodiment, no resampling is applied but the base resolution is in effect lower than the original resolution due to the filtering. It is noted that spatial prediction in a coding scheme may compress low-pass-filtered pictures more efficiently thanks to the increased amount of spatial correlation. According to an embodiment, resampling of the stereoscopic visual data is applied and the base resolution is hence lower than the original resolution.

According to an embodiment, no resampling is applied but the base resolution is in effect lower than the original resolution due to encoding parameter selections. For example, quantization of sample values or transform coefficients for the first and second region may be finer than for the areas outside the first and second region.

According to an embodiment, the first resolution and/or the second resolution is the same as the original resolution.

According to an embodiment, the at least part of the first region and the at least part of the second region are packed onto a same frame, such as a packed VR frame, and encoded.

According to an embodiment, the at least part of the first region and the at least part of the second region are encoded as separate pictures or frames.

According to an embodiment, the coding method is layered. The at least part of the first region at a first resolution is encoded onto a first scalable layer. The at least part of the second region at a second resolution is encoded onto a second scalable layer.

According to an embodiment, the coding method is layered. The at least part of the first region and the at least part of the second region are packed onto a same frame, such as a packed VR frame. The frame is encoded onto a first scalable layer.

According to an embodiment, at least a part of the at least one left view image and at least a part of the at least one right view image are encoded at the base resolution onto one or more scalable layers of a bitstream. For example, the at least a part of the at least one left view image, and the at least a part of the at least one right view image are packed to the same frame (e.g. packed VR frame), e.g. using top-bottom packing arrangement, and coded onto a base layer of the bitstream. According to another example, the at least a part of the at least one left view image is coded onto one scalable layer in the bitstream and the at least a part of the at least one right view image is coded onto another scalable layer in the bitstream.

According to an embodiment, the scalable layer(s) comprising sequences of at least part of the at least one left view image and at least a part of the at least one right view image make use of inter-picture prediction having a first stream access point interval. The first scalable layer (or the second scalable layer, when present) is encoded at a second stream or layer access point interval. The stream or layer access point interval may be such that each picture of the first scalable layer (or respectively the second scalable layer, when present), may independently be decoded from other pictures of the same scalable layer. This allows changing the first resolution (or respectively the second region) in a picture by picture manner.

In an embodiment for determining an area of interest, the area of interest may be determined unevenly for left and right eyes.

According to an embodiment, the at least part of the first region and the at least part of the second region are encoded as separate pictures or frames. The at least part of the first region is transmitted in a first transmission channel. The at least part of the second region is transmitted in a second transmission channel. In embodiment, a display device receives and processes both transmission channels. In another embodiment, a display device receives and/or processes one of the two transmission channels.

According to an embodiment, the coding method outputs a multi-layer bitstream, a first layer is transmitted in a first transmission channel, and a second layer is transmitted over a second transmission channel. In embodiment, a display device receives and processes both transmission channels. In another embodiment, a display device receives and/or processes one of the two transmission channels.

According to an embodiment, a display device, such e.g. a HMD, may provide feedback of viewing orientation to the encoding process. The viewing orientation information may be obtained for example with sensors included in or operationally connected to the display device, and tracking the yaw, pitch, and roll of the device. In another example, the viewing orientation may be user selectable for example using a pointing device, such as a joystick or a mouse. The determination of the area of interest may be based on the viewing orientation information.

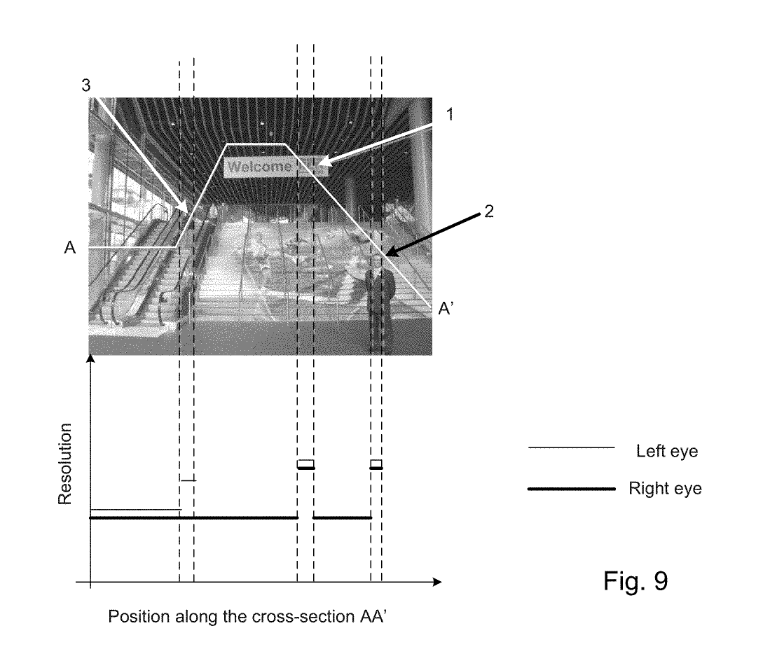

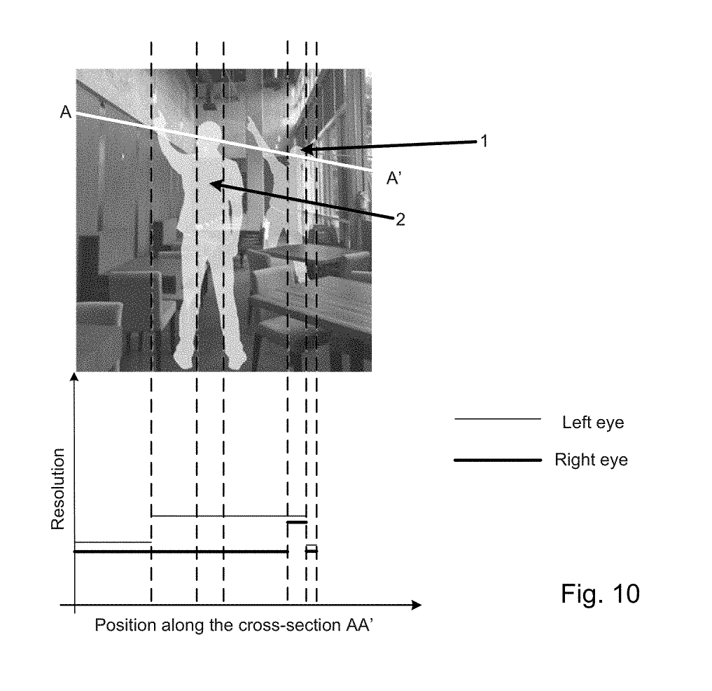

FIGS. 9, 10 illustrate examples of determining the regions of interest. The resolution for one eye remains constant within the regions of interest. FIG. 9 shows a recognized object 1, which is alphanumeric content and which may be determined to be a first object of interest in the stereoscopic visual data; and a recognized object 2, which is a person and which may be determined to be a second object of interest. Recognized object 2 is detected as a close-by object. Face of object 2 may be determined to be a region of interest within the second object of interest. Recognized object 3 may be determined as a region of interest based on detecting high-frequency content. FIGS. 9 to 14 show examples of a plurality of resolutions that may be determined for the left and the right eye along cross-sections AA′. In FIG. 9, a first resolution (lower) may be selected as a base resolution for both eyes. However, the at least portions of the objects of interest (alphanumeric content, face, high-frequency region) may be displayed to the right eye at a second resolution (higher). At least portions of the first and second objects of interest may be displayed to the left eye at a second resolution (higher), but the third object of interest may be determined to be displayed to the right eye at the first resolution (lower). Selecting different resolutions for different eyes reduces the required data rate needed to transfer the stereoscopic content to a head-mounted display.

FIG. 10 shows a recognized object 1, which may be determined as a first object of interest. In addition, a face may be detected for object 1 and the face may be determined to be a region of interest within the first object of interest. FIG. 10 shows also a recognized object 2, which may be determined to be a second object of interest. No face has been detected so object 2 forms a uniform area of interest without any further regions of interest there within. A first resolution (lower) may be selected for the left eye. However, the region of interest (face) of the first object of interest may be displayed to the left eye at a second resolution (higher). The second resolution may be also selected for the right eye for areas corresponding to the detected objects of interest. In this particular example, the second resolution is selected for a continuous area from the first object of interest to the second object of interest such that also areas between the detected objects of interest are covered by the second resolution. The most important region of interest, i.e. face of object 2, is rendered at the second resolution for both eyes. The rest of the objects of interest are rendered at the first resolution to the left eye and at the second resolution to the right eye. The lower resolution for the left eye enables a lower data transmission rate between the encoder and the head-mounted display. Dividing the object of interest to smaller regions having different resolutions for different eyes mitigates the reduction of perceived quality even though the data rate is reduced.

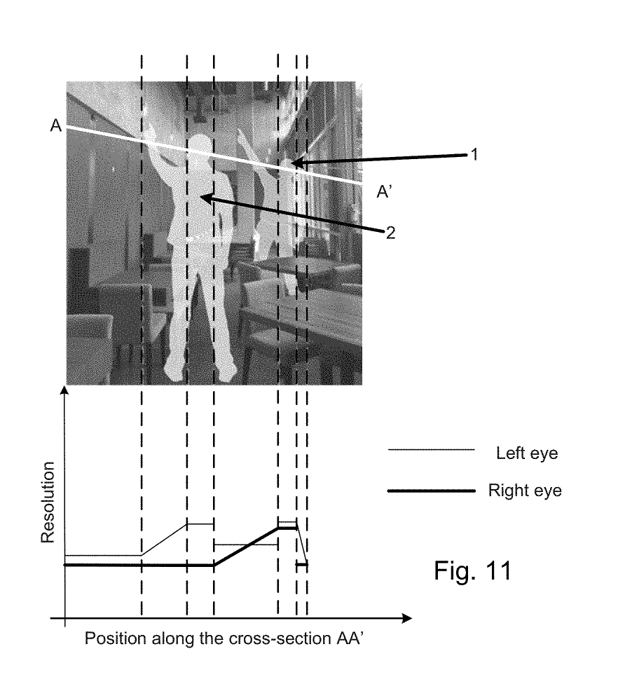

FIG. 11 illustrates an example of determining the regions of interest. The resolution for one eye remains constant or increases/decreases linearly as a function of the spatial location within the regions of interest. The regions of interest comprise the recognized objects 1, 2, wherein both the recognized objects 1 and 2 have faces. The region of interest (face) within object 2 is rendered at a first (lower) resolution for the right eye and at a second (higher) resolution for the left eye. In addition, the resolution within the second object of interest increases from the border of the object to reach the second resolution at the border of the region of interest within object 2. This area of changing resolution may be defined as a transition region. The change may be linear, but other methods may be applied as well. For example, change from the first resolution to the second resolution may be implemented as one or more stepwise increments or decrements. In an embodiment there may be only one step so a third (medium) resolution may be selected for the transition region (as shown for the left eye between the two objects of interest).

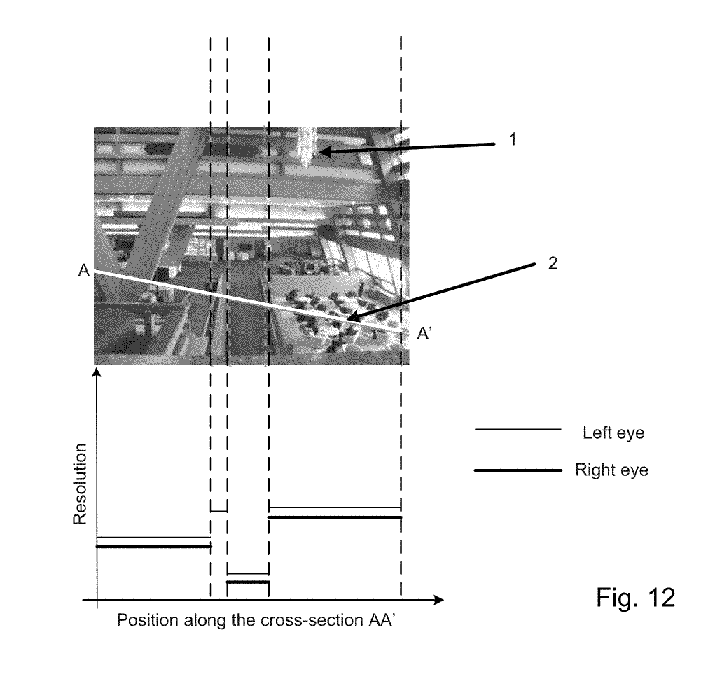

FIG. 12 illustrates an example of determining the regions of interest. The resolution for one eye remains constant within the regions of interest. Resolution for at least one eye is decreased in the low spatial frequency area of the image even though it is in the central area of the viewport. FIG. 12 shows recognized objects 1, 2 having high spatial frequency content. Resolution for at least one eye may be increased in the high spatial frequency area of the image.

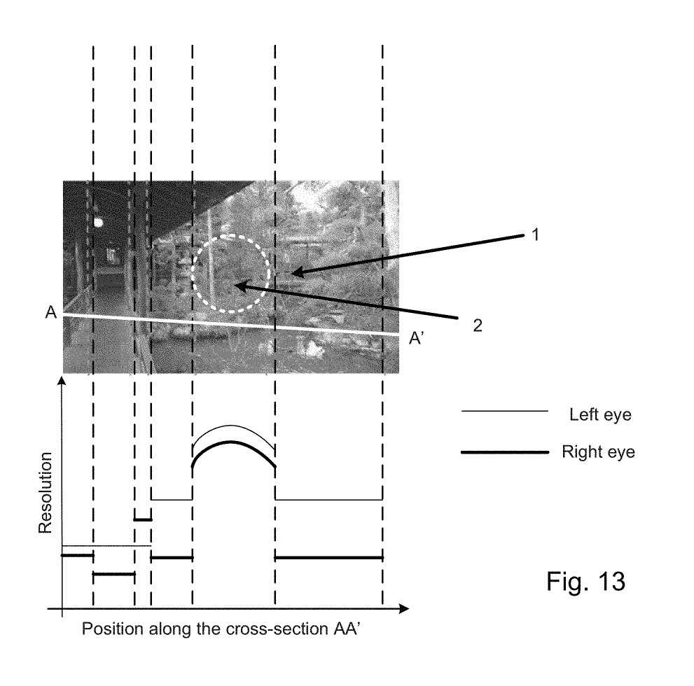

According to an embodiment, a display device may provide feedback of the head orientation to the encoding process. The head orientation information may be obtained for example with sensors included in or operationally connected to the display device, and tracking the yaw, pitch, and roll of the user's head. The determination of the area of interest may be based on the head orientation information and/or characteristics of the content. FIG. 13 illustrates an example of determining the regions of interest and estimating the gaze position based on the head orientation. Resolution for one eye remains constant or increased/decreases as a function of the spatial location within the regions of interest. In one embodiment, resolution is higher at the center of the region interest for at least one eye. Reference sign 1 indicates high-spatial frequency content, and reference sign 2 indicates gaze position estimation based on the head orientation.

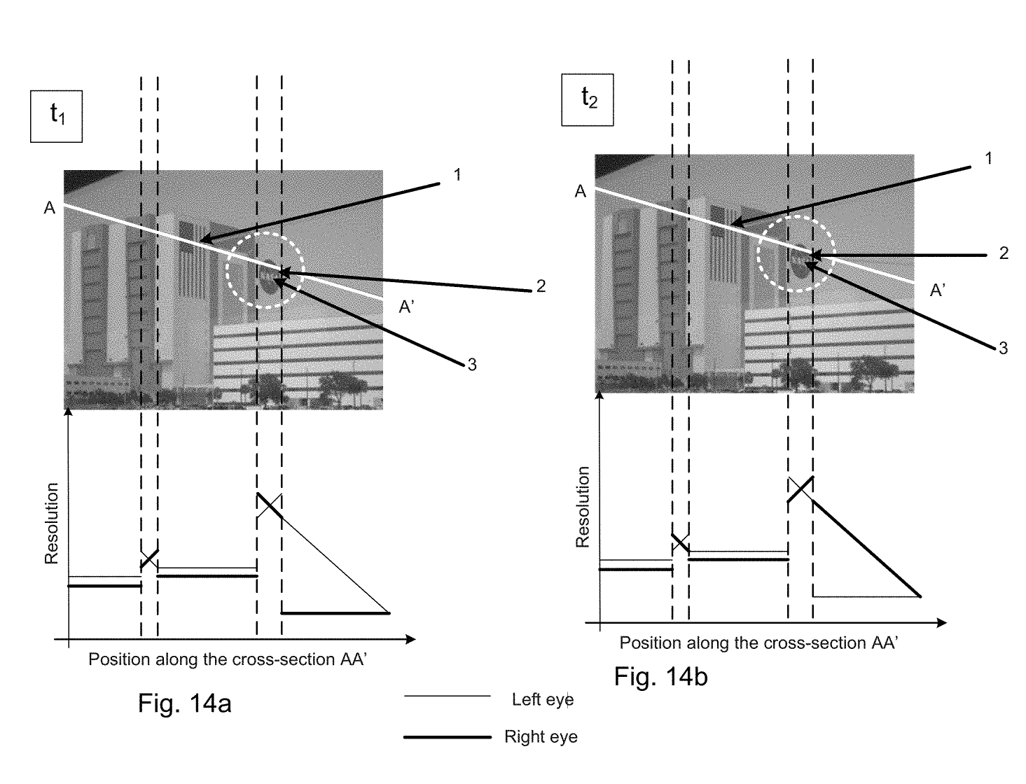

According to an embodiment, a display device may provide feedback of gaze position to the encoding process. The gaze position may be obtained for example with gaze tracking apparatus included in or operationally connected to the display device. The determination of the area of interest may be at least partially based on the gaze position. FIGS. 14a, 14b illustrate an example of determining the regions of interest and estimating the gaze position based on the gaze tracking. Both figures contain recognized object 1 and recognized object 2. In addition reference sign 3 indicates a gaze position estimated based on gaze tracking. The recognized object 1 is an object of interest being a high spatial frequency object. The recognized object 2 is an object of interest being an alphanumerical content. Resolution for one eye remains constant or increases/decreases as a function of the spatial location within the regions of interest, and the left-eye and right-eye resolution profiles are swapped sequentially with given times t₁ (FIG. 14a) and t₂ (FIG. 14b).

According to an embodiment, the first and second regions may define one or more overlapping areas, such as for example illustrated in FIGS. 14 and 14b. A resolution for the left eye at a first border of the overlapping area may correspond to a first resolution and a resolution for the left eye at a second border of the overlapping area may correspond to a second resolution. The resolution for the left may gradually increase from the first border to the second border. Respectively, a resolution for the right eye at the first border of the overlapping area may correspond to the second resolution, or a third resolution different from the second resolution, and a resolution for the right eye at a second border of the overlapping area may correspond to the first resolution, or a fourth resolution different from the first resolution. The resolution for the right eye may gradually decrease from the first border to the second border.

According to an embodiment, the resolutions for the different regions at the left and the right eye may be selected to complement each other. For example, a first region of a detected object of interest may be encoded, decoded or rendered at a first resolution for the left eye and at a second resolution for the right eye. Respectively, the first region may be encoded, decoded, or rendered at the second resolution for the left eye and at the first resolution for the right eye. This enables a more balanced viewing experience, because regions of the object or region of interest are rendered with a high resolution for at least one eye. Therefore, both eyes receive at least part of the high resolution image. As described above, the regions may be sequentially swapped to provide even more balanced view.

According to an embodiment, depth or disparity estimation may be performed for the stereoscopic visual data. A depth estimation algorithm may take a left and right view pictures as an input and compute local disparities between the two pictures. Each image may be processed pixel by pixel in overlapping blocks. Provided that left and right view pictures are vertically aligned, a horizontally localized search for a matching block in a second view may be performed for each block of pixels of a first view. Once a pixel-wise disparity is computed, the corresponding depth value z may be calculated by equation:

$$z = \frac{f \cdot b}{d + Δ d}$$

where f is the focal length of the camera and b is the baseline distance between cameras. Further, d may be considered to refer to the disparity estimated between corresponding pixels in the two cameras or the disparity estimated between corresponding pixels in the two cameras. The camera offset Δd may be considered to reflect a possible horizontal misplacement of the optical axes of the two cameras or a possible horizontal cropping in the camera frames due to pre-processing. Based on the estimated depth or disparity, one or more close-by objects can be determined on the basis on which are closes to the camera(s) than other parts of the stereoscopic visual data. The determination of the area of interest and/or the first and the second regions may be at least partially based on determined close-by objects.

According to an embodiment, a frequency domain representation of the stereoscopic visual data is derived. For example, the image may be partitioned to spatial regions, and a Fast Fourier Transform (FFT), Discrete Cosine Transform (DCT), or any other transform from the pixel domain to a transform domain may be performed for each spatial region. The obtained transform coefficients reveal properties of the signal within the spatial region, e.g. the amount and magnitude of high spatial frequencies. The amount and/or magnitude of high spatial frequencies may be thresholded e.g. based on respective averages within the stereoscopic visual data, and area(s) of interest may be selected based on exceeding the selected thresholds on the amount(s) and/or magnitude(s) of high spatial frequencies. Determination of an area of interest and/or the first and the second regions may be at least partially based on the determined low and/or high spatial frequency regions.

The encoding process may then utilize the determined areas of interest for determining on which resolutions the different parts of the input images are to be decoded.

In a rendering phase the following embodiment may be applied. At first, at least part of the first region at a first resolution corresponding to a first region of the left view image corresponding to a first portion of the area of interest is decoded. In addition, at least part of the second region at a second resolution corresponding to a second region of the right view image corresponding to a second portion of the area of interest is decoded. Then, the at least part of the first region and the at least part of the second region are rendered to a display, e.g. HMD.

It is appreciated that the human visual system is expected to process the merge the first region and the second region onto a perceived picture in a graceful manner so that the higher resolution of the respective regions is perceived.

According to an embodiment for rendering, the rendering comprises obtaining a device orientation information; determining either a first region or a second region to be rendered at a first resolution or a second region, respectively, based on the device orientation information; rendering either the at least part of the first region at a first resolution corresponding to a first region of the left view image corresponding to a first portion of the area of interest or the at least part of the second region at a second resolution corresponding to a second region of the right view image corresponding to a second portion of the area.

According to an embodiment for rendering, the rendering comprises obtaining a gaze direction; determining either a first region or a second region to be rendered at a first resolution or a second region, respectively, based on the gaze direction; rendering either the at least part of the first region at a first resolution corresponding to a first region of the left view image corresponding to a first portion of the area of interest or the at least part of the second region at a second resolution corresponding to a second region of the right view image corresponding to a second portion of the area.

According to an embodiment for rendering, the rendering comprises obtaining contextual information related to the objects of interest, e.g. object is a lead singer or a lead character, object is entering the viewport, object is tagged; determining either a first region or a second region to be rendered at a first resolution or a second region respectively, based on the contextual information; rendering either the at least part of the first region at a first resolution corresponding to a first region of the left view image corresponding to a first portion of the area of interest or the at least part of the second region at a second resolution corresponding to a second region of the right view image corresponding to a second portion of the area.

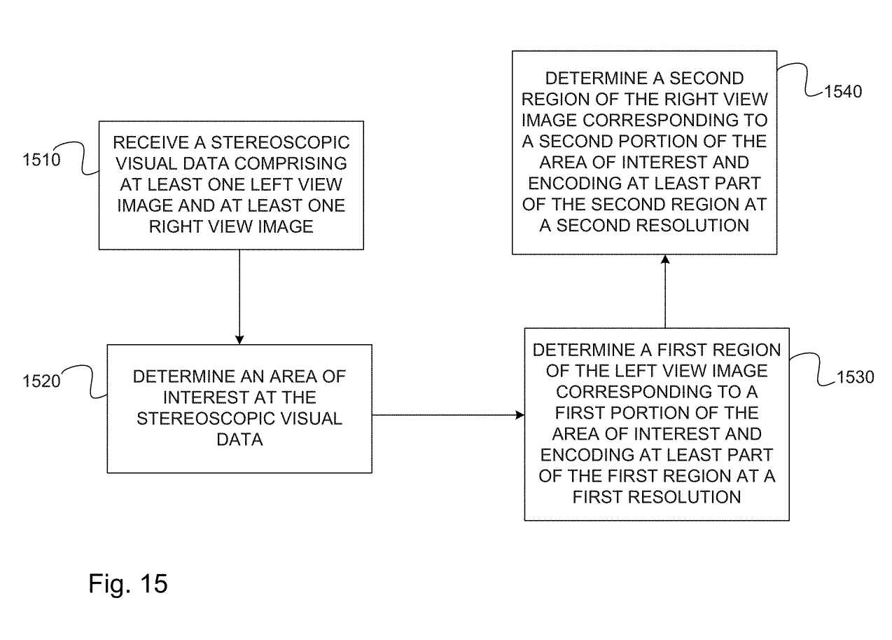

A method for encoding according to an embodiment is illustrated in FIG. 15 as a flowchart. In the encoding method the video data is generated and sent to a HMD, the example of which is shown in FIG. 3. The method according to example of FIG. 15 comprises receiving 1510 stereoscopic visual data, the stereoscopic visual data comprising at least one left view image and at least one right view image; determining 1520 an area of interest at the stereoscopic visual data; determining 1530 a first region of the left view image corresponding to a first portion of the area of interest and encoding at least part of the first region at a first resolution; and determining 1540 a second region of the right view image corresponding to a second portion of the area of interest and encoding at least part the second region at a second resolution.

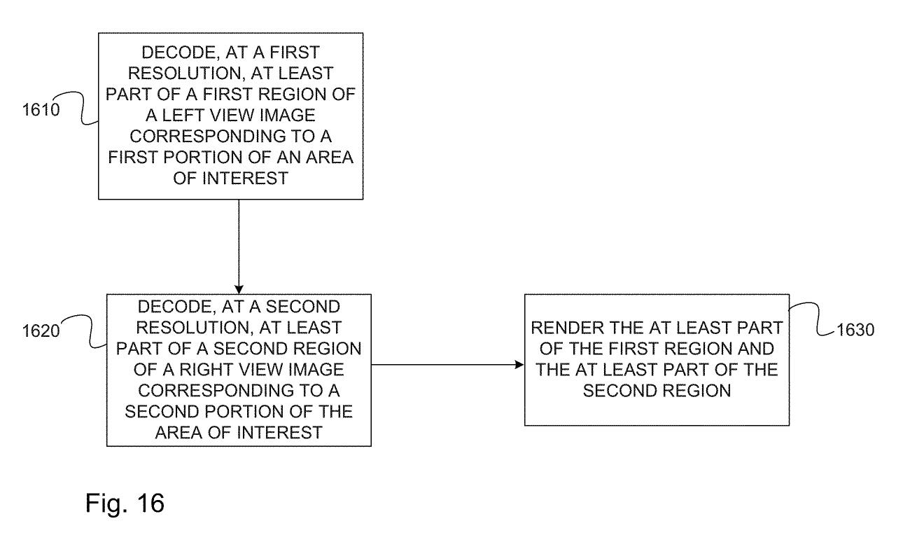

A method for decoding according to an embodiment is illustrated in FIG. 16 as a flowchart. The decoding may be implemented by a HMD that receives the data and displays different resolutions for the eyes. The method according to example of FIG. 16 comprises decoding 1610, at a first resolution, at least part of a first region of a left view image corresponding to a first region of an area of interest; decoding 1620, at a second resolution, at least part of a second region of a right view image corresponding to a second region of the area of interest; and rendering 1630 the at least part of the first region and the at least part of the second region.

In previous, methods according to embodiments were discussed by means of various examples. An apparatus according to an embodiment comprises means for implementing the method. For example, the apparatus comprises means for receiving stereoscopic visual data, the stereoscopic visual data comprising at least one left view image and at least one right view image; determining an area of interest at the stereoscopic visual data; determining a first region of the left view image corresponding to a first portion of the area of interest and encoding at least part of the first region at a first resolution; and determining a second region of the right view image corresponding to a second portion of the area of interest and encoding at least part the second region at a second resolution. Apparatus, according to another embodiment, comprises means for decoding, at a first resolution, at least part of a first region of a left view image corresponding to a first region of an area of interest; decoding, at a second resolution, at least part of a second region of a right view image corresponding to a second region of the area of interest; and rendering the at least part of the first region and the at least part of the second region. The means of the apparatus can be implemented as at least one processor and a memory including computer program code.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are

several variations and modifications, which may be made without departing from the scope of the present disclosure as, defined in the appended claims.

1. A method comprising:
receiving stereoscopic visual data, the stereoscopic visual data comprising at least one left view image and at least one right view image;
determining an area of interest at the stereoscopic visual data;
determining a first region of the left view image corresponding to a first portion of the area of interest and encoding at least part of the first region at a first resolution; and
determining a second region of the right view image corresponding to a second portion of the area of interest and encoding at least part of the second region at a second resolution.

2. The method according to claim 1, wherein the first and second regions comprise at least partially different portions of the area of interest.

3. The method according to claim 1, wherein the first and second resolutions are different.

4. The method according to claim 1, wherein the first and second regions are at least partially overlapping.

5. The method according to claim 4, wherein the first and second regions define an overlapping area, wherein the resolution at the first region gradually increases towards a first border of the overlapping area, and wherein the resolution at the second region gradually decreases towards the first border of the overlapping area.

6. The method according to claim 1, further comprising applying a first filtering to at least part of the first region to obtain the first resolution and applying a second filtering to at least part of the second region to obtain the second resolution.

7. The method according to claim 1, wherein the first and second resolutions are each higher than a base resolution of the stereoscopic visual data.

8. The method according to claim 7, wherein the first resolution is equal to the second resolution.

9. The method according to claim 7, wherein the base resolution is lower than the first resolution and/or the second resolution.

10. The method according to claim 7, further comprising encoding at least a part of the left view image and at least a part of the right view image onto one or more scalable layers of a bitstream, wherein the at least part of the first region is encoded onto a first scalable layer of the bitstream, and the at least part of the second region is encoded onto a second scalable layer of the bitstream, the first and second scalable layers being different layers of the one or more scalable layers.

11. The method according to claim 1, further comprising selecting the area of interest, the first region, or the second region based on at least one of the following: detecting a close-by object; detecting a high spatial frequency object; detecting a face of an object; detecting an alphanumeric object; detecting an orientation of a user and detecting a gaze position of a user.

12. The method according to claim 1, the stereoscopic visual data comprises a portion of 360-degree virtual reality content.

13. An apparatus comprising at least one processor, memory including
computer program code, the memory and the computer program code
configured to, with the at least one processor, cause the apparatus to:
receive stereoscopic visual data, the stereoscopic visual data comprising at least one left view image and at least one right view image;
determine an area of interest at the stereoscopic visual data;
determine a first region of the left view image corresponding to a first portion of the area of interest and encoding at least part of the first region at a first resolution; and
determine a second region of the right view image corresponding to a second portion of the area of interest and encoding at least part of the second region at a second resolution.

14. A computer program product embodied on a non-transitory computer readable medium, comprising computer program code configured to, when executed on at least one processor, cause an apparatus or a system to
receive stereoscopic visual data, the stereoscopic visual data comprising at least one left view image and at least one right view image;
determine an area of interest at the stereoscopic visual data;
determine a first region of the left view image corresponding to a first portion of the area of interest and encoding at least part of the first region at a first resolution; and
determine a second region of the right view image corresponding to a second portion of the area of interest and encoding at least part of the second region at a second resolution.

15. A method comprising:
decoding, at a first resolution, at least part of a first region of a left view image corresponding to a first portion of an area of interest;
decoding, at a second resolution, at least part of a second region of a right view image corresponding to a second portion of the area of interest; and
rendering the at least part of the first region and the at least part of the second region.

16. The method according to claim 15, further comprising:
obtaining at least one of device orientation information, head orientation information, and a gaze direction;
determining either the first region or the second region to be rendered at the first resolution or the second resolution, respectively, based on the device orientation information, the head orientation information, the gaze direction, or a combination thereof; and
rendering either the at least part of the first region at the first resolution corresponding to a first region of the left view image corresponding to a first portion of the area of interest or the at least part the second region at the second resolution.

17. An apparatus comprising at least one processor, memory including
computer program code, the memory and the computer program code
configured to, with the at least one processor, cause the apparatus to:
decode, at a first resolution, at least part of a first region of a left view image corresponding to a first portion of an area of interest;
decode, at a second resolution, at least part of a second region of a right view image corresponding to a second portion of the area of interest; and
render the at least part of the first region and the at least part of the second region.

18. A computer program product embodied on a non-transitory computer readable medium, comprising computer program code configured to, when executed on at least one processor, cause an apparatus or a system to:
decode, at a first resolution, at least part of a first region of a left view image corresponding to a first portion of an area of interest;
decode, at a second resolution, at least part of a second region of a right view image corresponding to a second portion of the area of interest; and
render the at least part of the first region and the at least part of the second region.
